(19) United States
(12) Patent Application Publication
(10) Pub. No.: US 2022/0342124 A1
(43) Pub. Date: Oct. 27, 2022

(54) LIMITING CHROMATIC DISPERSION IN GRADIENT REFRACTIVE-INDEX OPTICS

(71) Applicant: Vadient Optics, LLC, Beaverton, OR (US)

(72) Inventors: John Paul Harmon, Albany, OR (US); George Williams, Vashon, WA (US)

(21) Appl. No.: 17/811,187

(22) Filed: Jul. 7, 2022

Related U.S. Application Data
(63) Continuation-in-part of application No. 14/888,665, filed on Nov. 2, 2015.
(60) Provisional application No. 61/818,534, filed on May 2, 2013.
(60) Provisional application No. 61/818,544, filed on May 2, 2013.
(60) Provisional application No. 61/818,548, filed on May 2, 2013.
(60) Provisional application No. 61/819,104, filed on May 3, 2013.

(51) Int. Cl. G02B 3/00

(52) U.S. Cl. CPC G02B 3/0087

(57) ABSTRACT

An optic having a refractive-index gradient comprises first and second materials. The first material includes at least one nanoparticle species and has a first volume-fraction profile and a first refractive index n₁(λ) varying in dependence on wavelength λ. The second material includes at least one polymer species and has a second volume-fraction profile and a second refractive index n₂(λ) varying in dependence on the wavelength λ. The first and second volume-fraction profiles define the refractive-index gradient of the optic, where, for a longer wavelength λ_{R} and a shorter wavelength λ_{B}: n₁(λ_{B})−n₂(λ_{B}) and n₁(λ_{R})−n₂(λ_{R}) differ by less than a threshold T that limits optical power in the optic.

### CROSS-REFERENCE TO RELATED APPLICATIONS

This application is a continuation-in-part of U.S. patent application Ser. No. 14/888,665, filed 2 Nov. 2015, which is a national phase from International Application Serial Number PCT/US2014/036707, filed 2 May 2014, which claims priority to the following applications: U.S. Provisional Patent Application Ser. No. 61/818,534, filed 2 May 2013, U.S. Provisional Patent Application Ser. No. 61/818,544, filed 2 May 2013, U.S. Provisional Patent Application Ser. No. 61/818,548, filed 2 May 2013, and U.S. Provisional Patent Application Ser. No. 61/819,104, filed 3 May 2013, the entirety of each of which is hereby incorporated herein by reference for all purposes.

### TECHNICAL FIELD

The disclosure herein relates generally to gradient refractive-index (GRIN) optics and more particularly to GRIN optics having low chromatic dispersion.

### BRIEF DESCRIPTION OF THE DRAWINGS

The disclosure herein will be better understood from reading the following Detailed Description with reference to the attached drawing figures, wherein:

FIG. 1 shows aspects of an example GRIN optic;

FIG. 2 is a graph of example first and second volume-fraction profiles of a GRIN optic, each plotted as a function of a coordinate r;

FIG. 3 shows aspects of an optic exhibiting chromatic dispersion;

FIG. 4 is a graph of refractive index as a function of wavelength for example first and second materials;

FIG. 5 is a graph of mid-visible band refractive index for selected materials plotted against the difference in refractive index across the visible band;

FIG. 6 is a graph of refractive index as a function of wavelength for different example first and second materials;

FIG. 7 is a graph of example first, second, and third volume-fraction profiles of a GRIN optic, each plotted as a function of a coordinate r;

FIGS. 8A through 8E are graphs of refractive-index spectra for example materials; and

FIG. 9 shows aspects of an example apparatus configured for additive manufacture of a GRIN optic.

### DETAILED DESCRIPTION

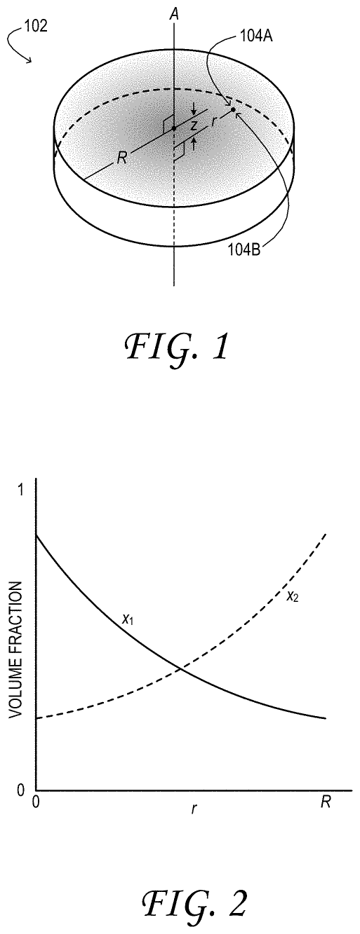

FIG. 1 shows aspects of an example gradient refractive index (GRIN) optic 102. In the illustrated example, optic 102 takes the form of a disc symmetric about optical axis A. Optic 102 comprises first material 104A and second material 104B and optionally may comprise additional materials (vide infra). The first and second materials are distributed inhomogeneously within optic 102. The first material is distributed according to a first volume-fraction profile x₁(r), and the second material is distributed according to a second volume-fraction profile x₂(r). The graph of FIG. 2 shows example first and second volume-fraction profiles, each plotted as a function of a coordinate r. Generally speaking, r is a geometric coordinate of optic 102. In the illustrated example r corresponds to radial distance from axis A. In other examples r may correspond to a different geometric coordinate or to a linear combination of geometric coordinates. In some examples a GRIN optic may have more or less symmetry than optic 102 and a different overall shape.

First material 104A has a first refractive index n₁(λ), and second material 104B has a second refractive index n₂(λ), where λ denotes wavelength. In the examples herein the first refractive index is greater than the second refractive index for λ_{B}<λ<λ_{R}. The difference in the refractive index of the first and second materials is denoted Δn(λ)=n₁(λ)−n₂(λ). To a good approximation, the observed refractive index n in radially symmetric optic 102, at any value of r, is a linear combination of n₁(λ) and n₂(λ) weighted according to the respective volume fractions of the first and second materials at that same r:

n(λ,r)=x₁(r)n₁(λ)+x₂(r)n₂(λ). (1)

For an optic including a third material, etc., the weighted sum is extended accordingly. In combination with n₁(λ) and n₂(λ), the first and second volume-fraction profiles define a gradient in the observed refractive index of the optic. Thus, for a given wavelength λ (or sufficiently narrow range of wavelengths), it is possible to engineer a desired refractive-index gradient by appropriate material selection and control over the first and second volume-fraction profiles x₁(r) and x₂(r).

In optic 102 of FIG. 1, the observed refractive index decreases with increasing distance r from optical axis A, thereby defining a radial component of the refractive-index gradient. In more particular examples, the radial component may be such that the refractive index changes as a function of one or more terms of r′, for example where x≥2. In other examples, the radial component may have a more complex refractive-index distribution. For some radially symmetric optics the radial component may be a superposition of radial components—e.g.,

n(λ,r)=n₀+Δn(a₂r²+a₄r⁴+a₆r⁶+ . . . ), (2)

where coefficients aₓ weight corresponding radial powers r′, and where no is the refractive index at the center of the optic. In some examples the radial component may vary as a function of depth z along the optical axis. The refractive index along z may also vary as a function of one or more terms of z^{x}, for example where x≥2. In the case where the refractive index varies with both r and z, the refractive index at any location may be represented as

n(λ,r,z)=n₀+Δn(a₂r²+a₄r⁴+a₆r⁶+b₁z,b₁z²+a₂b₁r²z+a₂b₂r²z²+ . . . ), (3)

where coefficients bₓ weight corresponding depth powers z^{x}.

Thus, the observed refractive-index may vary in directions perpendicular and/or parallel to the optical axis. GRIN optics having refractive-index profiles of lower symmetry are also envisaged. In particular, an optic consonant with this disclosure may have a refractive index profile with no translational or rotational symmetry about axes normal to a mean plane. An optic consonant with this disclosure may have a surface profile with no translational or rotational symmetry about axes normal to a mean plane. Equally envisaged are freeform optics where the refractive-index gradient is asymmetric about the optical axis, as can be described by more complex polynomial representations. In optic 102, however, optical power derives from the controlled gradient of the observed refractive index in the radial direction, ∂n/∂r. As described hereinafter, one way to exert such control is to form optic 102 from a cured coalescence of ‘ink’ droplets providing the controlled volume fractions of the first and second materials. Such an optic can be engineered to provide optical power—e.g., convergent focus of light rays passing through the optic. In such examples, the refractive-index gradient provides a function analogous to the gradient entry and/or exit surface angles of a conventional spherical lens. Accordingly, optic 102 can be engineered to provide optical power despite having no curvature on the entry or exit faces. Nevertheless, optic 102 optionally may include at least one curved surface for additional optical power. The skilled reader will note that a ‘gradient’ defined as a scalar departs somewhat from standard usage; the direction of the gradient is assumed to be the direction of greatest change unless otherwise stated.

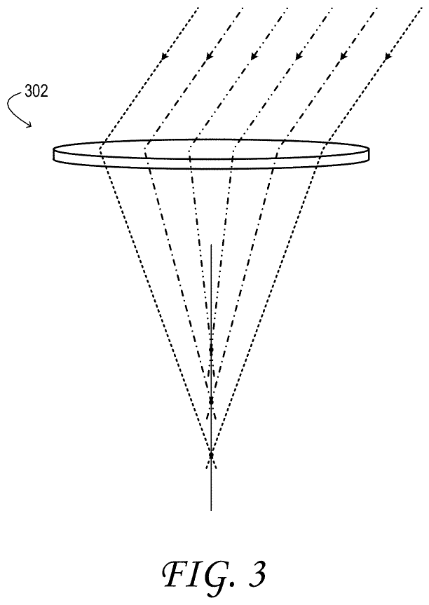

A GRIN optic may exhibit chromatic aberration due to undesired chromatic dispersion. As shown in FIG. 3, light rays of different wavelengths may enter optic 302 in parallel but converge at different focal points. In contrast to optics of fixed refractive index, where all chromatic dispersion originates interfacially, a GRIN optic may exhibit chromatic dispersion originating internally. In order for a GRIN optic to provide par focus over a broad wavelength range, such dispersion must be controlled to within prescribed limits. The amount or severity of chromatic dispersion in a radially symmetric GRIN optic can be related empirically to various dispersion metrics—e.g.,

D∂n_{Y}/∂r=∂n_{B}/∂r−∂n_{R}/∂r (4)

where n_{B} and n_{R} represent the observed refractive index for wavelengths at opposite ends of any band of interest, at any r within the optic. As a practical matter, the amount of primary dispersion may be expressed relative to ∂n_{Y}/∂r, the gradient of the observed refractive index n_{Y} in the middle of the band. Relative primary dispersion metrics, such as D, depend only on the wavelength-dependent refractive indices of the materials used, not on the distribution or magnitude of the refractive-index gradient within the optic, nor on the volume fractions of the materials therein.

First material 104A of optic 102 has a first refractive index n₁(λ) that varies in dependence on wavelength λ, and second material 104B has a second refractive index n₂(λ) that also varies in dependence on the wavelength. Abbreviating nᵢ(λ_{B}), nᵢ(λ_{Y}), and nᵢ(λ_{B}) as n_{iB}, n_{iY}, and n_{iR}, respectively, and expanding in terms of the volume fractions x, of each material i in optic 102,

∂n_{B}/∂r=∂/∂r(x₁(r)n_{1B}+x₂(r)n_{2B}+ . . . )=∂x₁/∂r n_{1B}+∂x₂/∂r n_{2B}+ . . . , (5)

where x₁(r)+x₂(r)+ . . . =1, and likewise for ∂y_{Y}/∂r and ∂n_{R}/∂r. In the special case of only two materials, ∂x₂/∂r=−∂x₁/∂r. Substituting into eq 2,

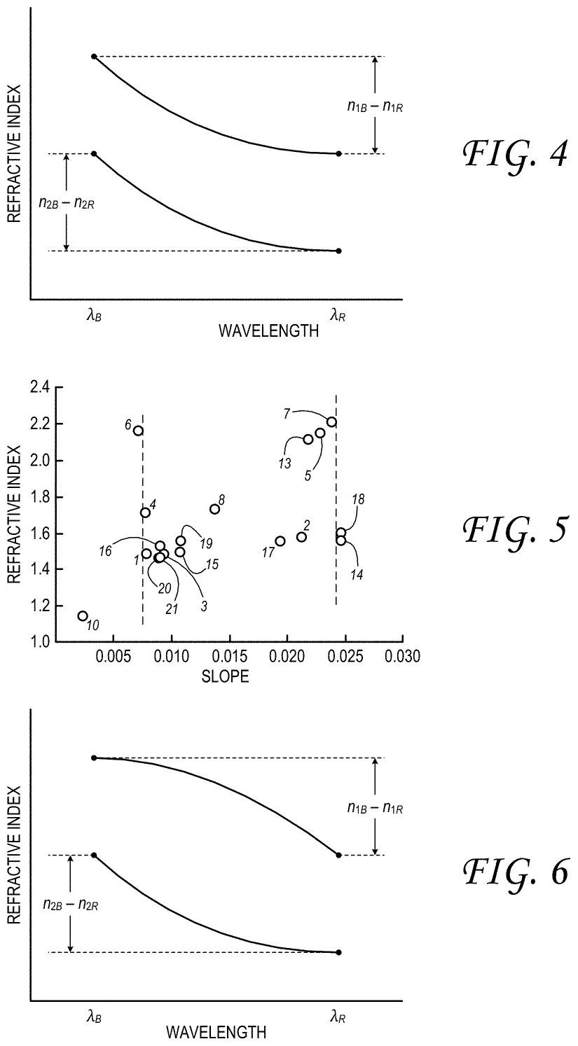

DΔn_{Y}=Δn_{B}−Δn_{R}, (6)

where Δn_{B}=n_{1B}−n_{2B}, Δn_{B}=n_{1Y}−n_{2Y}, Δn_{B}=n_{1R}−n_{2R}, and λ_{B}<λ_{Y}<λ_{R}. Thus, in order to urge D toward zero in a GRIN optic limited to two materials, the materials must have similar n_{B}−n_{R}. This feature is shown by example in FIG. 4.

A practical way to realize optical materials with refractive indices amenable to the approach herein is to base each material on a polymer species or mixture of polymer species. A polymer-based material can be deposited in a controlled manner in the form of liquid droplets, which coalesce and subsequently solidify in a desired shape (vide infra). Accordingly, first material 104A and second material 104B of optic 102 (and a third material, etc., in examples in which additional materials are incorporated) may each include at least one polymer species. The term ‘matrix’ refers herein to the at least one polymer species on which a material is based. In examples in which a substantially transparent optic is desired, each polymer species may be an optically transparent polymer species. Suitable polymer species include propylene carbonate (PC), di(ethylene glycol) diacrylate (DEGDA), fluoroethylene glycol diacrylates (FEGDA, FEGDA(2)), neopentyl glycol diacrylate (NPGDA), 2-hydroxyethylmethacrylate (HEMA) and hexanediol diacrylate (HDDA or HDODA) polymers, bisphenol A novolak epoxy (SU8), polyacrylate (PA), polymethyl methacrylate (PMMA), polystyrene, polydiacetylene (PDA), poly(ethylene glycol diacrylate (PEGDA), and poly[(2,3,4,4,5,5-hexafluorotetrahydrofuran-2,3-diyl)(1,1,2,2-tetrafluoroethyl-ene)] (CYTOP)). Other polymer species providing desired physicochemical properties may also be used.

In some examples, one or more nanoparticle species may be dispersed in a matrix in order to modify the wavelength-dependent refractive index of the matrix. Accordingly, first material 104A and/or second material 104B of optic 102 (and/or a third material, etc., in examples in which additional materials are incorporated) may be composite materials of fixed composition. More particularly, each include at least one nanoparticle species dispersed in a matrix. The term ‘nanocomposite material’ refers herein to a dispersion of at least one nanoparticle species in a matrix. In examples in which a substantially non-scattering optic is desired, an average nanoparticle size may be selected for each nanoparticle species such that the size is too small to effect significant Rayleigh or Mie scattering in optic 102. Accordingly, the selected average size may depend on the wavelength band of interest. For non-scattering optics engineered for the visible wavelengths, the selected average size may be less than 50 nanometers (nm), for example. Further, the coefficient of extinction, combining absorbance and reflection, of a nanocomposite material may be 10% or lower, preferably 1% or lower, over the band of interest.

Nanoparticle species suitable for modifying the refractive index of a matrix include various metal, metal oxide, chalcogenide, and semiconductor nanoparticles. More particular examples include zinc sulfide (ZnS), zirconium dioxide (ZrO₂), barium titanate (BTO), bismuth germanate (BGO), nanodiamond (NanoD), zinc oxide (ZnO), beryllium oxide (BeO), magnesium oxide (MgO), aluminum nitride (AlN), wurtzite AlN (w-AlN), titanium dioxide (TiO₂), tellurium dioxide (TeO₂), aluminum oxide imide (Al₂O₃HN), molybdenum trioxide (MoO₃), aluminum-doped ZnO (AZO), germanium-doped silicon (SiGe), silicon dioxide (SiO₂), and lithium fluoride (LiF) nanoparticles, hollow SiO₂ nanospheres (h-SiO₂), and shelled variants of any of the foregoing nanoparticles supporting ZrO₂, MgO, SiO₂, ZnO, or other shells, including those that cause the nanoparticles to be more or less reactive with the matrix. Other nanoparticle species providing desired physicochemical properties may also be used. For some nanoparticle species, nanoparticle stability and/or dispersability in a matrix can be enhanced by chemical modification of the surface of each nanoparticle. For instance, the nanoparticles may be surface-functionalized by a suitable ligand—e.g., acrylic acid, phosphonic acid, or a silane—that provides chemical compatibility dispersability with the matrix, thereby enhancing optical clarity. Ligands may be selected to covalently bond to the surface of the nanocrystal via an ‘anchor’ moiety and/or repel each other via a ‘buoy’ moiety, thereby discouraging aggregation. In some examples, a distal site on a ligand may bond covalently to a monomer of the matrix so that dispersability is maintained during polymerization.

Returning now to the specifics of chromatic dispersion, eq 4 suggests certain criteria for first material 104A and second material 104B for controlling chromatic dispersion in optic 102. To first order, Δn_{B} and Δn_{R} should differ by less than a threshold T that limits optical power in the optic. In some examples, the threshold may be about 1% of Δn_{Y}, such that D<0.01. In other examples the threshold can be defined without explicit reference to a central wavelength in the band of interest. For instance, T may be set to about 1% of the average of Δn_{B} and Δn_{R}, where the corresponding figure of merit,

D′=2(Δn_{B}−Δn_{R})/(Δn_{B}+Δn_{R}), (7)

is less than 0.01.

Table 1 lists the refractive indices of selected polymer and nanoparticle species at three different wavelengths: λ_{B}=486.13 nm, λ_{Y}=587.56 nm, and λ_{R}=656.27 nm.

TABLE 1
Refractive indices and metrics for selected polymer and nanoparticle
species and nanocomposite materials.

| | species | n(λ_{B}) | n(λ_{Y}) | n(λ_{R}) | A | P_{YR} | P_{BY} |
|---|---|---|---|---|---|---|---|
| 1 | PA | 1.4995 | 1.4942 | 1.4917 | 63 | 0.32 | 0.68 |
| 2 | SU8 | 1.5994 | 1.5849 | 1.5782 | 28 | 0.32 | 0.68 |
| 3 | PMMA | 1.4973 | 1.4914 | 1.488 | 53 | 0.37 | 0.63 |
| 4 | BeO | 1.7239 | 1.7186 | 1.7162 | 93 | 0.31 | 0.69 |
| 5 | AlN | 2.1704 | 2.1543 | 2.1476 | 51 | 0.29 | 0.71 |
| 6 | w-AlN | 2.173 | 2.1658 | 2.1659 | 164 | −0.01 | 1.01 |
| 7 | ZrO₂ | 2.2272 | 2.2148 | 2.2034 | 51 | 0.48 | 0.52 |
| 8 | MgO | 1.7471 | 1.7375 | 1.7334 | 54 | 0.30 | 0.70 |
| 9 | SiGe | 4.397 | 3.9838 | 3.8463 | 5 | 0.25 | 0.75 |
| 10 | h-SiO₂ | 1.1544 | 1.1529 | 1.1521 | 66 | 0.35 | 0.65 |
| 11 | TiO₂ | 3.0639 | 2.9124 | 2.8537 | 9 | 0.28 | 0.72 |
| 12 | TiO₂/ZrO₂ | 2.785 | 2.6799 | 2.637 | 11 | 0.29 | 0.71 |
| 13 | 4:1 ZrO_{2/}MgO | 2.13118 | 2.11934 | 2.1094 | 51 | 0.46 | 0.54 |
| 14 | 1% SiGe/10% h-SiO_{2/}SU8 | 1.582876 | 1.565689 | 1.558271 | 23 | 0.30 | 0.70 |
| 15 | 1% TiO₂/ZrO₂/PMMA | 1.510177 | 1.503285 | 1.49949 | 47 | 0.36 | 0.64 |
| 16 | 20% BeO/PMMA | 1.54262 | 1.53684 | 1.53364 | 60 | 0.36 | 0.64 |
| 17 | 5% TiO₂/PMMA | 1.57563 | 1.56245 | 1.556285 | 29 | 0.32 | 0.68 |
| 18 | 1.8% TiO₂/SU8 | 1.625761 | 1.608795 | 1.601159 | 25 | 0.31 | 0.69 |
| 19 | 10% ZrO₂/PMMA | 1.57029 | 1.56374 | 1.55954 | 52 | 0.39 | 0.61 |
| 20 | 6% h-SiO₂/PMMA | 1.476726 | 1.47109 | 1.467846 | 53 | 0.37 | 0.63 |
| 21 | 5% h-SiO₂/PMMA | 1.480155 | 1.474475 | 1.471205 | 53 | 0.37 | 0.63 |

To a good approximation, the wavelength-dependent refractive index nᵢ(λ) of a nanocomposite material i is given by:

nᵢ(λ)=xₐnₐ(λ)=x_{b}(r)n_{b}(λ)+ . . . , (8)

where indices a, b, etc. span every species (polymer, nanoparticle, or otherwise) present in the nanocomposite material. Thus, incorporation of a nanoparticle species greater in refractive index than the matrix will increase the refractive index of the nanocomposite relative to the matrix, and incorporation of a nanoparticle species lower in refractive index than the matrix will decrease the refractive index of the nanocomposite relative to the matrix. As shown in Table 1, most solid nanoparticle species have refractive indices greater than typical polymer matrices, while hollow (e.g., air-filled) nanospheres have refractive indices lower than typical polymer matrices.

The principles introduced above are further illustrated in the GRIN-optic examples of Table 2, wherein a first material 104A and a second material 104B are co-dispersed according to varying volume-fraction profiles. The quantities Δn_{B}, Δn_{Y}, Δn_{R}, and D are defined according to eq 4 hereinabove. In Example 1 first material 104A is BeO nanoparticles and second material 104B is PA. In this example, Δn_{B} and Δn_{R} differ by about 0.045% of the average of Δn_{B} and Δn_{R}, and by about 0.045% of Δn_{Y}. In Example 2 first material 104A is AlN nanoparticles and second material 104B is SU8. In this example, Δn_{B} and Δn_{R} differ by about 0.28% of the average of Δn_{B} and Δn_{R}, and by about 0.28% of ΔnΔn_{R}. In Example 3 first material 104A is ZrO₂ nanoparticles and second material 104B is SU8. In this example, Δn_{B} and Δn_{R} differ by about 0.41% of the average of Δn_{B} and Δn_{R}, and by about 0.42% of Δn_{Y}. In Example 4, first material 104A is w-AlN nanoparticles and second material 104B is PA. In this example, Δn_{B} and Δn_{R} differ by about 0.10% of the average of Δn_{B} and Δn_{R}, and by about 0.10% of Δn_{Y}.

FIG. 5 provides an alternative, graphical illustration for selection of the first and second materials according to the criteria hereinabove. The graph shows n_{Y} plotted against the ‘slope’, n_{B}−n_{R}, for some of the materials in Table 1. The different materials corresponding to the plot markers in FIG. 5 are identified by numeric labels which correspond to the numbered materials in the table. Desirable pairs of first and second materials are located along lines of equal or approximately equal slope, as shown in the graph. Naturally, in order to provide significant optical power, Δn_{Y} between the first and second materials should be as large as possible.

The foregoing examples demonstrate that GRIN optics with limited chromatic dispersion can be based on binary configurations of selected first and second materials. For at least two reasons, however, binary configurations of first and second pure materials have finite utility. First, the number of available binary configurations is combinatorially limited in view of the range of available nanocomposite materials. In other words, it may not always be possible to select first and second materials having desired properties, with refractive indices that differ by the same amount at both ends of the desired wavelength band.

The second reason is more easily understood with reference to FIG. 5, which shows the wavelength-dependent refractive indices of two different materials. For these two materials the quantities Δn_{B} and Δn_{R} are identical. However, the curvature d²n/dλ² differs markedly for the two materials. A GRIN optic based on these first and second materials would achieve par focus for blue and red light, but intermediate wavelengths would not be in focus.

TABLE 2
Metrics for example nanocomposite materials.

| example | first | second | Δn_{B} | Δn_{Y} | Δn_{R} | D | D′ | E_{YR} | E_{BY} |
|---|---|---|---|---|---|---|---|---|---|
| 1 | BeO | PA | 1.4917 | 1.4917 | 1.4917 | −4.46E−04 | −4.46E−04 | 1.00E+00 | 0.00E+00 |
| 2 | AlN | SU8 | 1.5782 | 1.5782 | 1.5782 | 2.81E−03 | 2.81E−03 | 0.00E+00 | 1.00E+00 |
| 3 | ZrO₂ | SU8 | 1.488 | 1.488 | 1.488 | 4.13E−03 | 4.15E−03 | 1.81E+00 | −8.08E−01 |
| 4 | w-AlN | PA | 1.7162 | 1.7162 | 1.7162 | −1.04E−03 | −1.04E−03 | 3.71E+00 | −2.71E+00 |
| 5 | 4:1 ZrO₂/MgO | SU8 | 2.1476 | 2.1476 | 2.1476 | 1.09E−03 | 1.09E−03 | 5.59E+00 | −4.59E+00 |
| 6 | 1% SiGe/10% h-SiO₂/SU8 | 1.8% TiO₂/SU8 | 2.1659 | 2.1659 | 2.1659 | −6.96E−05 | −7.00E−05 | −7.27E+01 | 7.37E+01 |
| 7 | 1% TiO_{2/}ZrO_{2/}PMMA | 10% ZrO₂/PMMA | 2.2034 | 2.2034 | 2.2034 | 1.04E−03 | 1.05E−03 | 6.43E+00 | −5.43E+00 |
| 8 | 20% BeO/PMMA | 6% h-SiO_{2/}PMMA | 1.7334 | 1.7334 | 1.7334 | 1.52E−03 | 1.52E−03 | −4.40E−01 | 1.44E+00 |
| 9 | 5% TiO₂/PMMA | 5% h-SiO₂/PMMA | 2.637 | 2.637 | 2.637 | 1.18E−01 | 1.15E−01 | 2.78E−01 | 7.22E−01 |

One remedy for both of the above issues is to incorporate additional polymer and/or nanoparticle species into first material 104A and/or second material 104B of optic 102. To first order, one additional species can be used to balance Δn_{B} and Δn_{R} for mismatched first and second materials, changing the slope of one to better match the slope of the other. More generally, predetermined volume fractions of one or more additional species may be selected so as to minimize any desired residual between n₁(λ) and n₂(λ)+k, where k is a constant that matches the two terms at one wavelength within the band of interest. In some examples the residual to be minimized is an absolute residual. In some examples the residual to be minimized is a sum-of-squares type residual.

Accordingly, first material 104A may include two or more nanoparticle species in some examples, and second material 104B may include one or more nanoparticle species in these and other examples. In more particular examples it may be desirable to incorporate nanoparticles such as hollow nanospheres, with a refractive index lower than the matrix. This tactic increases the maximum available Δn. In practice, a lower-index second material may be based on a relatively low-index polymer species M; then another, slightly higher-index, color-compensating polymer species N may be added to provide color balance with a higher-index first material. In that case the higher-index first material may be based on polymer species M or N and a dispersed nanoparticle species. Naturally, additional polymer species may also be incorporated into the first material.

In view of the discussion above, additional figures of merit can be defined which quantify the degree to which the first and higher derivatives of n₁(λ) and n₂(λ) match in the interval between λ_{B} and λ_{R}. For instance,

E_{YR}=(Δn_{Y}−Δn_{R})/(Δn_{B}−Δn_{R}) (9)

is one measure of non-linearity of the relative refractive-index spectra of the first and second materials. In some examples, a GRIN optic with |E_{YR}|<0.02 may be desired. Likewise,

E_{BY}=(Δn_{B}−Δn_{Y})/(Δn_{B}−Δn_{R}) (10)

is another measure of non-linearity of the relative refractive-index spectra of the first and second materials. In some examples, a GRIN optic with | E_{BY}|<0.02 may be desired. In eqs 6 and 7, and throughout this disclosure, Δ represents a difference evaluated between the first and second materials. However, the general approach of eqs 6 and 7 is applicable to any pair of intermediate compositions j and k formed from a mixture of the first and second materials, such as mixtures formed along the refractive-index gradient. Thus, in some examples a GRIN optic may be desired wherein |E_{YR}| and/or |E_{BY}| is less than 0.02 for any pair of intermediate compositions j and k, where Δ=Δⱼₖ. In yet another variant of this figure of merit, a quantity akin to D (of eq 4) maybe computed, where Δn_{Y} is replaced by Δn_{λ}=n₁(λ)−n₂(λ), evaluated at any wavelength in the band of interest. Thus,

D_{λ}=(Δn_{B}−Δn_{R})/Δn_{λ}. (11)

In some examples, it may be required that D_{λ}<0.01 for a predetermined number of different wavelengths λ in the band, which reports heuristically on curvature matching.

The extensions above are now further illustrated in additional GRIN-optic examples from Table 2. In Example 5 first material 104A is a homogeneous mixture of four parts ZrO₂ nanoparticles to one part MgO nanoparticles, and second material 104B is SUB. In this example, D is about 0.11%, the E_{YR} is about 5.6, and the E_{BY} is about −4.6. In Example 6 first material 104A is a homogeneous mixture of 1 vol % SiGe nanoparticles at 2% doping and 10 vol % h-SiO₂ nanospheres incorporating 66 vol % air; second material 104B is a homogeneous mixture of 1.8 vol % TiO₂ nanoparticles in SUB. In this example, D is about −0.0070%, the E_{YR} is about −73, and the E_{BY} is about 73. In Example 7 first material 104A is a homogeneous mixture of 1 vol % TiO₂/ZrO₂ nanoparticles at 30 vol % ZrO₂ shell in PMMA, and second material 104B is a homogeneous mixture of 10 vol % ZrO₂ in PMMA. In this example, D is about 0.11%, the E_{YR} is about 6.4, and the E_{BY} is about −5.4. In Example 8 first material 104A is a homogeneous mixture of 20 vol % BeO in PMMA, and second material 104B comprises 6 vol % h-SiO₂ nanospheres (as above) in PMMA. In this example, D is about 0.15%, the E_{YR} is about −0.44, and the E_{BY} is about 1.4. The method of mixing nanoparticles to tune the change in refractive index to match that of a host polymer may be repeated for any host polymer in which the nanoparticles can be dispersed.

The foregoing examples demonstrate GRIN optics with low dispersion for typical broadband applications. However, if a high dispersion is desired—e.g., for making a compact prismatic optic—then the same principles above can be used to engineer an optic with high D. For instance, in Example 9 of Table 2, first material 104A is a homogeneous mixture of 5 vol % TiO₂ nanoparticles in PMMA, and second material 104B is a homogeneous mixture of 5 vol % h-SiO₂ nanospheres (as above) in PMMA. In this example, D is about 12%, the E_{YR} is about 0.28, and the E_{BY} is about 0.72.

Despite the utility of each of the figures of merit defined above, another strategy is to select or formulate first and second material compositions based on their individual refractive-index spectra. In particular, materials having very low curvature d²n/dλ² in the band of interest may be selected. In other words, n₁(λ) and n₂(λ) are made as linear as possible over the band of interest, so that a close match between Δn_{B} and Δn_{R} provides par focus for intermediate wavelengths as well. In that spirit, suitable figures of merit reporting on the curvature may be defined and used.

For example, the Abbe number A expresses the relation between refractive capacity and chromatic dispersion for individual first or second materials i-viz.,

Aᵢ=(nᵢ(λ_{Y}−)−1)/(nᵢ/(λ_{B})−nᵢ(λ_{R})). (12)

In some examples Aᵢ is required to exceed a threshold of about 30 for the first and/or second material. In other examples Aᵢ must exceed 50.

Alternatively or in addition, partial chromatic dispersion metrics may be defined as follows.

P_{YR}=(nᵢ(λ_{Y})−nᵢ(λ_{R}))/(nᵢ(λ_{B})−nᵢ(λ_{R})), and (13)

P_{BY}=(nᵢ(λ_{B})−nᵢ(λ_{Y}))/(nᵢ(λ_{B})−nᵢ(λ_{R})). (14)

In some examples it may be required that |P_{YR}|<0.7 for the first and/or second materials. In some examples it may be required that |P_{BY}|<0.65 for the first and/or second materials. Figures of merit based on partial chromatic dispersion parameters can be extended to any of the intermediate compositions comprising a first volume fraction of first material 104A and a second volume fraction of the second material 104B. In some examples, accordingly, it may be required that P_{YR} evaluated for any, some, or all of the intermediate compositions differ by less than 0.02. Alternatively or in addition, it may be required that P_{BY} evaluated for any, some, or all of the intermediate compositions differ by less than 0.02. These metrics are listed in Table 1.

In these and other examples, the optic may comprise compositional blends that, over an Abbe number range greater than 15, have a difference of the absolute value of partial dispersion values which is less than 0.025 from the average partial dispersion value over the Abbe number range.

In still other examples ∂n/∂r of the first and second materials may be varied independently of each other. This allows the two materials to have different optical power, providing secondary color correction, wherein additional points in the color spectrum can be brought into focus.

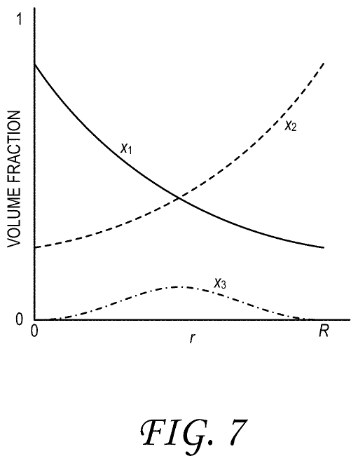

Even though some of the examples from Table 2 incorporate three or more material components, operationally such components are premixed (at fixed volume fraction) into the feedstocks of first material 104A and second material 104B. Thus, when the feedstocks are deposited to form a GRIN optic there is only one independently variable volume-fraction profile, x₁(r), usable to control the refractive index gradient. This disclosure is not limited to that approach, however, for a natural extension is to incorporate in optic 102 a third material 104C, etc., having a distinct third refractive index n₃(λ), etc., that varies in dependence on the wavelength λ. This approach is represented in FIG. 7. When included, the third material is distributed in the optic according to a third volume-fraction profile x₃(r). Any number of additional materials may be likewise included, with x₁(r)+x₂(r)+x₃(r)+ . . . =1. Each additional material provides an additional degree of freedom, enabling more precise control over n(λ, r) and the gradient(s) thereof. In some examples a third material may include at least one nanoparticle species and/or polymer species. Operationally, any type of numeric optimization can be used to engineer the several xᵢ(r), including optimization based on ray-tracing computer software.

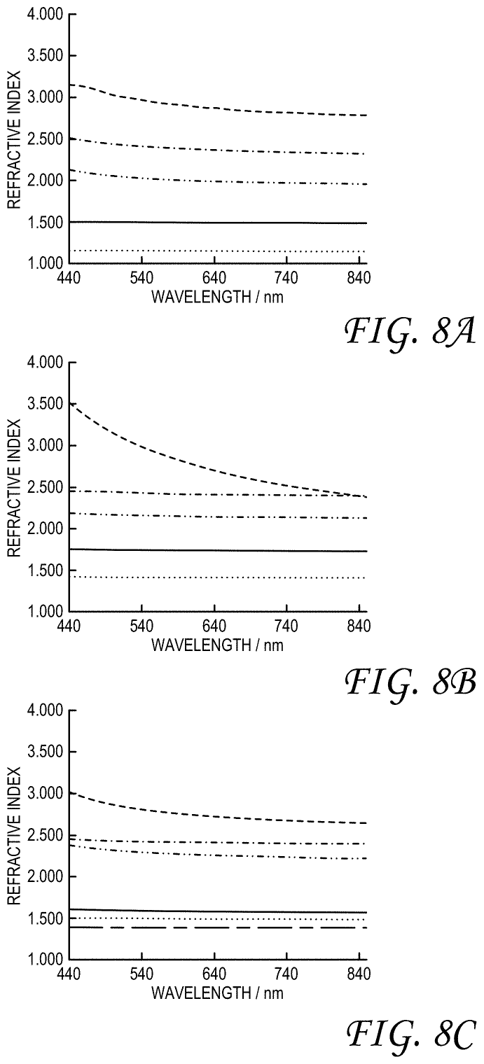

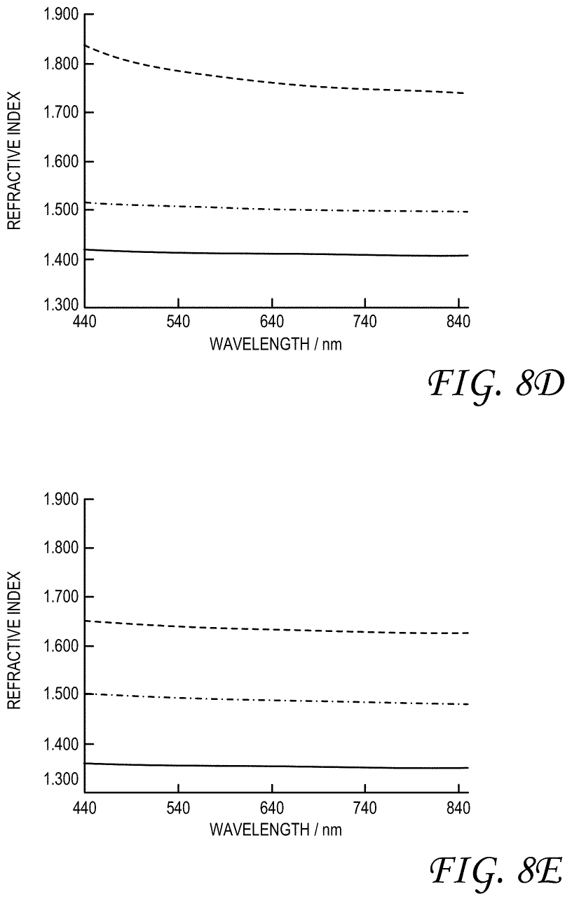

To further enable the skilled reader to make GRIN optics of controlled chromatic dispersion, FIGS. 8A through 8E provide refractive index spectra of additional optical materials. In FIG. 8A the dashed line corresponds to TiO₂ from the Sopra database, the dot-dashed line corresponds to ZnS, the double-dot-dashed line corresponds to ZnO, the solid line corresponds to SiO₂, and the dotted line corresponds to h-SiO₂. In FIG. 8B the dashed line corresponds to BGO, the dot-dashed line corresponds to NanoD, the double-dot-dashed line corresponds to ZrO₂, the solid line corresponds to MgO, and the dotted line corresponds to FEGDA(2). In FIG. 8C the dashed line corresponds to rutile TiO₂, the dot-dashed line corresponds to MoO₃, the double-dot-dashed line corresponds to TeO₂, the solid line corresponds to PC from Sultana, the dotted line corresponds to NPGDA and the line with alternating long and short dashes corresponds to LiF. In FIG. 8D the dashed line corresponds to 22% TiO₂ in NPGDA, the dot-dashed line corresponds to 2% ZrO₂ in NPGDA, and the solid line corresponds to FEGDA. In FIG. 8E the dashed line corresponds to 22% ZrO₂ in NPGDA, the dot-dashed line corresponds to NPGDA, and the solid line corresponds to 22% h-SiO₂ in FEGDA.

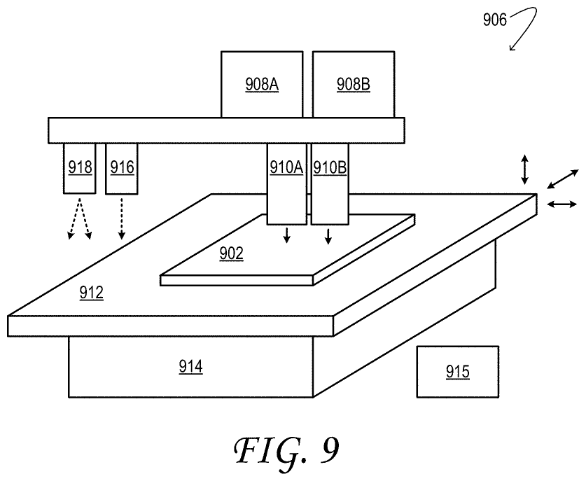

FIG. 9 shows aspects of a non-limiting example apparatus configured for additive manufacture of an article. Additional details are found in U.S. patent application Ser. No. 16/224,512 entitled NANOCOMPOSITE OPTICAL-DEVICE WITH INTEGRATED CONDUCTIVE PATHS and Ser. No. 16/507,658 entitled PRINTED CIRCUIT BOARD WITH INTEGRATED OPTICAL WAVEGUIDES; FUNCTIONALLY GRADED POLYMER MATRIX NON-COMPOSITES BY SOLID FREEFORM FABRICATION, Solid Freeform (SFF) Symposium (2003); and POLYMER MATRIX NANOCOMPOSITES BY INK-JET PRINTING, Solid Freeform (SFF) Symposium (2005), which are hereby incorporated herein by reference for all purposes. Nevertheless, various other deposition methods and apparatuses are also applicable to the approach herein.

Apparatus 906 of FIG. 9 includes reservoir 908A holding a first ink and reservoir 908B holding a second ink. The first ink is a liquid precursor of first material 104A, in which the one or more polymer species takes resinous form, is not cured and/or not cross-linked. Likewise the second ink is a liquid precursor of second material 104B, in which the one or more polymer species takes resinous form, is not cured and/or not cross-linked. Reservoirs 908A and 908B are coupled fluidically to print heads 910A and 910B, respectively. Each print head is configured to discharge the corresponding ink with high spatial accuracy onto optic 902, arranged on platen 912. More particularly, each print head is configured to add individual voxels of ink to the optic. In examples in which a third, etc., material is used, the apparatus may include a separate reservoir and print head for additional, corresponding inks. In these and other examples, both the order of deposition of the ink droplets and the location of each droplet may be controlled to high precision.

Platen 912 is coupled mechanically to translational stage 914. The translational stage is configured to adjust the displacement of the platen along each of the three Cartesian axes. In other examples, displacement along any, some, or all of the Cartesian axes may be adjusted by movement of the print heads instead of, or in addition to, the platen. In still other examples, a translational stage may adjust the relative displacement of the platen and print heads along two Cartesian axes, and a rotational stage (not shown in the drawings) may be used to adjust the azimuth of voxel deposition in the plane orthogonal to the two Cartesian axes. In every case, the adjustment is controlled (e.g., servomechanically), pursuant to control signals from controller 915. More particularly, the controller may be configured to transmit, to the translational stage and to the first and second print heads, signal defining the first and second volume-fraction profiles, for each of a plurality of voxel-thick layers of the optic. The controller may compute these patterns by parsing a 3D digital model of the optic to be fabricated and returning the intersection of the 3D digital model with a series of cutting planes corresponding to the plurality of layers.

Continuing in FIG. 9, apparatus 906 includes a directed optical emitter 916 and a diffuse optical emitter 918. The optical emitters may comprise lasers or lamps of any emission profile suitable for curing the inks. The displacement of the optical emitters relative to platen 912 may be controlled in the same manner as the displacement of the print heads relative to the platen. The directed optical emitter may be used for selective, localized curing of certain regions of voxels, and the diffuse optical emitter may be used to cure larger regions of the optic. In examples in which one of the inks is thermally curable, a heat emitter may be included.

No aspect of the foregoing description or drawings should be interpreted in a limiting sense, because numerous variations, extensions, and omissions are equally envisaged. Although the concrete examples are GRIN optics operative in the visible spectrum, the longer wavelength λ_{R} and the shorter wavelength λ_{B} may lie within one or more of a visible, near-infrared, short-wave infrared, or thermal infrared spectrum. In still other examples, the wavelengths may lie in other regions of the electromagnetic spectrum. Although axially symmetric optics are illustrated herein, the same principles can be used to engineer optics of other symmetries and/or freeform optics, where the refractive-index gradient is expressed as a polynomial of arbitrary order, such as a Zern-like or orthogonal polynomial. In making a GRIN optic, the refractive index may be changed by increasing and decreasing the mix of the low index ink and the high index ink that are mixed. One can also create ‘grey scale’ inks, premixed before deposition. These have the same ‘color balance’ (slope) as the low and high index inks, alone or mixed. The added materials may be either (metal oxide, semiconductor, or metal) nanoparticles, other inorganic nanoparticles, polymer nanoparticles, or other polymer matrix materials, including the surfactants and ligand chemical coatings on the nanoparticles.

It will be understood that the configurations and/or approaches described herein are exemplary in nature, and that these specific examples are not to be considered in a limiting sense, because numerous variations are possible. The specific routines or methods described herein may represent one or more of any number of processing strategies. As such, various acts illustrated and/or described may be conducted in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An optic having a refractive-index gradient, the optic comprising:
a first material including at least one nanoparticle species, the first material having a first volume-fraction profile and a first refractive index n₁(λ) varying in dependence on wavelength Δ; and
a second material including at least one polymer species, the second material having a second volume-fraction profile and a second refractive index n₂(λ) varying in dependence on the wavelength Δ, wherein for a longer wavelength Δ_{R} and a shorter wavelength Δ_{B}:
n₁(λ_{B})−n₂(λ_{B}) and n₁(λ_{R})−n₂(λ_{R}) differ by less than a threshold T that limits optical power in the optic, and
wherein the first and second volume-fraction profiles define the refractive-index gradient of the optic.

2. The optic of claim 1 wherein the first refractive index n₁(λ) is greater than the second refractive index n₂(λ) for λ_{B}<λ<λ_{R}.

3. The optic of claim 1 wherein the first and second materials are composite materials of fixed composition, and wherein the first material includes at least one polymer species.

4. The optic of claim 3 wherein the first material includes two or more nanoparticle species.

5. The optic of claim 3 wherein the second material includes one or more nanoparticle species.

6. The optic of claim 1 further comprising a third material having a third volume-fraction profile with a third refractive index n₃(λ) varying in dependence on wavelength Δ.

7. The optic of claim 1 wherein the threshold Tis one percent of an average of n₁(λ_{R})−n₂(λ_{R}) and n₁(λ_{B})−n₂(λ_{B}).

8. The optic of claim 1 wherein for λ_{Y}=(λ_{R}+λ_{B})/2,
a relation between refractive capacity and chromatic dispersion of the first material, (n₁(λ_{Y})−1)/(n₁(λ_{B})−n₁ (λ_{R})), is greater than 30, and
a relation between refractive capacity and chromatic dispersion of the second material, (n₂(λ_{Y})−1)/(n₂(λ_{B})−n₂(λ_{R})), is greater than 30.

9. The optic of claim 1 wherein the nanoparticle species is one of two or more nanoparticle species dispersed in the first material.

10. The optic of claim 1 wherein the polymer species is one of two or more polymer species of the second material.

11. The optic of claim 1 wherein the nanoparticle species is surface-functionalized with ligands configured to enhance dispersability within a polymer.

12. The optic of claim 1 wherein, for λ_{Y}=(λ_{R}+λ_{B})/2, the threshold T is one percent of n₁(λ_{Y})−n₂(λ_{Y}).

13. The optic of claim 1 wherein the first and second materials comprise a cured coalescence of inkjet-printed droplets.

14. The optic of claim 1 wherein for λ_{Y}=(λ_{R}+λ_{B})/2,
a partial chromatic dispersion value of the first material, |(n₁(λ_{Y})−n₁(λ_{R}))/(n₁(λ_{B})−n₁ (λ_{R}))|, is less than 0.7, or
a partial chromatic dispersion value of the second material, |(n₂(λ_{Y})−n₂(λ_{R}))/(n₂(λ_{B})−n₂(λ_{R}))|, is less than 0.7.

15. The optic of claim 1 wherein the first and second volume-fraction profiles define a plurality of compositions i, each comprising a first volume fraction of the first material and a second volume fraction of the second material and having a corresponding plurality of partial chromatic dispersion values

|nᵢ(λ_{Y})−nᵢ(λ_{R}))/(nᵢ(λ_{R})−nᵢ(λ_{B}))|,
and wherein the plurality of partial chromatic dispersion values differ by less than 0.02 for all i.

16. The optic of claim 1 wherein for λ_{Y}=(λ_{R}+λ_{B})/2,
a partial chromatic dispersion value of the first material, |(n₁(λ_{B})−n₁(λ_{Y}))/(n₁(λ_{B})−n₁(λ_{R}))|, is less than 0.65, or
a partial chromatic dispersion value of the second material, |(n₂(λ_{B})−n₂(λ_{Y}))/(n₂(λ_{B})−n₂(λ_{R}))|, is less than 0.65.

17. The optic of claim 1 wherein the first and second volume-fraction profiles define a plurality of intermediate compositions i, each comprising a first volume fraction of the first material and a second volume fraction of the second material and having a corresponding plurality of partial chromatic dispersion values

|(nᵢ(λ_{Y})×nᵢ(λ_{R}))/(nᵢ(λ_{B})−nᵢ(λ_{R}))|,
and wherein the plurality of partial chromatic dispersion values differ by less than 0.02 for all i.

18. The optic of claim 1 further comprising an optical axis, wherein the refractive-index gradient includes a radial refractive-index gradient, and wherein the refractive index changes with increasing distance r from the optical axis.

19. The optic of claim 18 wherein the radial refractive-index gradient is such that the refractive index varies as a sum of one or more terms of r^{x} with x≥2.

20. The optic of claim 18 wherein the radial refractive-index gradient varies as a function of depth z along the optical axis.

21. The optic of claim 1 comprising at least one curved surface.

22. The optic of claim 1 wherein the nanoparticle species includes metal, metal oxide, chalcogenide, and/or semiconductor nanoparticles, including any of zinc sulfide (ZnS), barium titanate (BTO), zirconium dioxide (ZrO₂), zinc oxide (ZnO), beryllium oxide (BeO), magnesium oxide (MgO), aluminum nitride (AlN), wurtzite AlN (w-AlN), titanium dioxide (TiO₂), tellurium dioxide (TeO₂), aluminum oxide imide (Al₂O₃HN), molybdenum trioxide (MoO₃), aluminum-doped ZnO (AZO), germanium-doped silicon (SiGe), silicon dioxide (SiO₂), and lithium fluoride (LiF) nanoparticles, hollow SiO₂ nanospheres (h-SiO₂), and shelled variants thereof.

23. The optic of claim 1 wherein the polymer species includes any of di(ethylene glycol) diacrylate (DEGDA), neopentyl glycol diacrylate (NPGDA), 2-hydroxyethylmethacrylate (HEMA) and hexanediol diacrylate polymers (HDDA or HDODA), bisphenol A novolak epoxy (SU8), polyacrylate (PA), polymethyl methacrylate (PMMA), polystyrene, polydiacetylene (PDA), poly(ethylene glycol diacrylate (PEGDA), and poly[(2,3,4,4,5,5-hexafluorotetrahydrofuran-2,3-diyl)(1,1,2,2-tetrafluoroethyl-ene)] (CYTOP)).

24. The optic of claim 1 wherein the optic has a refractive index profile with no translational or rotational symmetry about axes normal to a mean plane.

25. The optic of claim 1 wherein the optic has a surface profile with no translational or rotational symmetry about axes normal to a mean plane.
